(19) United States
(12) Patent Application Publication
(10) Pub. No.: US 2004/0158567 A1
(43) Pub. Date: Aug. 12, 2004

(54) Constraint driven schema association

(75) Inventors: Richard D. Dettinger, Rochester, MN (US); Frederick A. Kulack, Rochester, MN (US); Richard J. Stevens, Mantorville, MN (US); Eric W. Will, Oronoco, MN (US)

Correspondence Address: William J. McGinnis, Jr., IBM Corporation, Dept. 917, 3605 Highway 52 North, Rochester, MN, 55901-7829, US

(73) Assignee: International Business Machines Corporation, Armonk, NY

(21) Appl. No.: 10/365,098

(22) Filed: Feb. 12, 2003

(51) Int. Cl. G06F 17/00

(52) U.S. Cl. 707/100

(57) ABSTRACT

A method, apparatus and article of manufacture for mapping schemas to one another. The fields of a target schema are characterized by constraint metadata. The constraint metadata represents rules or guidelines used to identify source fields in a source schema, which source fields are candidates for being mapped to the target fields.

### BACKGROUND OF THE INVENTION

1. Field of the Invention

The present invention generally relates to data processing, and more particularly to schema mapping.

2. Description of the Related Art

The term “schema” is often used to describe a particular model for organizing data. Because data may be represented by different schemas, is often desirable to associate data represented by one schema with similar or equivalent data represented in a different schema. This process of associating data represented by different schemas is often referred to as “schema mapping”. Situations requiring schema mapping arise, for example, when exchanging data between two different parties or when deploying a solution designed to work with one schema in an environment where data is represented in a different schema.

Current schema mapping techniques have limited application. One schema mapping technique provides some type of rendition of the two schemas involved, allowing the user to select, and thereby associate, fields from each schema using a provided user interface. This approach may suffice for very simple schemas, but does not scale to larger schemas where the list of fields is very large and the only available information to base a mapping decision on is the name of each field.

More advanced schema mapping techniques involve some degree of data sampling, whereby a user is provided some advice and guidance on what to map based on equivalent or similar value sets for a pair of fields. Such a solution is useful when samples of data for each set of fields is available and the values are represented consistently. However, this solution cannot be used if only schema information is available or there is some conversion process required to compare values founded each of the schemas.

Therefore, a need exists for a schema mapping technique that provides more accurate recommendations on associations between fields described in different schemas.

### SUMMARY OF THE INVENTION

The present invention generally provides methods, apparatus and articles of manufacture for mapping schemas to one another.

In one embodiment, a method of mapping a first schema to a second schema is provided. The method includes retrieving constraint data for the first schema, wherein the constraint data characterizes a field of the first schema; for each field of the second schema, determining whether the field of the second schema satisfies the constraint data; and if so, mapping the field of the second schema to the field of the first schema.

Another embodiment for mapping a first schema to a second schema includes retrieving constraint data for the first schema, wherein the constraint data comprises a plurality of constraints each characterizing one of a plurality of fields of the first schema; and for each of the plurality of constraints which characterizes a particular one of the plurality of fields of the first schema, determining whether any fields of the second schema satisfy the constraint. Each field of the second schema which satisfies at least one of the plurality of constraints is then ranked. The highest ranked field of the second schema which satisfies at least one of the plurality of constraints is mapped to the particular one field of the first schema characterized by the constraint.

In yet another embodiment the foregoing methods are implemented by a computer readable medium containing a program which, when executed, performs the mapping.

Still another embodiment provides a system for mapping schemas. The system includes a source schema defining a plurality of source fields, a target schema defining a plurality of target fields, schema association constraints and schema map generator. Schema association constraints are defined for the target schema and include a constraints set for each of the plurality of target fields. The constraints defined by the constraints set for a given target field characterize acceptable field attributes from the source schema for the given target field and a schema map generator configured to map one or more of the plurality of target fields to one or more of the plurality of source fields according to the schema association constraints.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic diagram of a computer embodying aspects of the invention.

FIG. 2 is a diagram illustrating the logical relationship between various software components.

FIG. 3 is a diagram illustrating mappings between a source data representation and a target data representation, wherein the mappings are defined by a schema association constraints data structure.

FIG. 4 is one embodiment for performing constraint-based schema mapping.

FIG. 5 is one embodiment of a method for finding candidate fields in a source schema which match target field constraints.

FIG. 6 is one embodiment of a method for ranking candidate source fields which match target field constraints.

FIG. 7 shows one embodiment of a networked system in which aspects of the invention are implemented as part of a data abstraction model.

FIG. 8 a logical and runtime view of the system of FIG. 7.

### DETAILED DESCRIPTION OF THE PREFERRED EMBODIMENTS

The present invention provides methods, apparatus and articles of manufacture for mapping schemas to one another. The fields of a target schema are characterized by constraint metadata. The constraint metadata represents rules or guidelines used to identify source fields in a source schema, which source fields are candidates for being mapped to the target fields.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

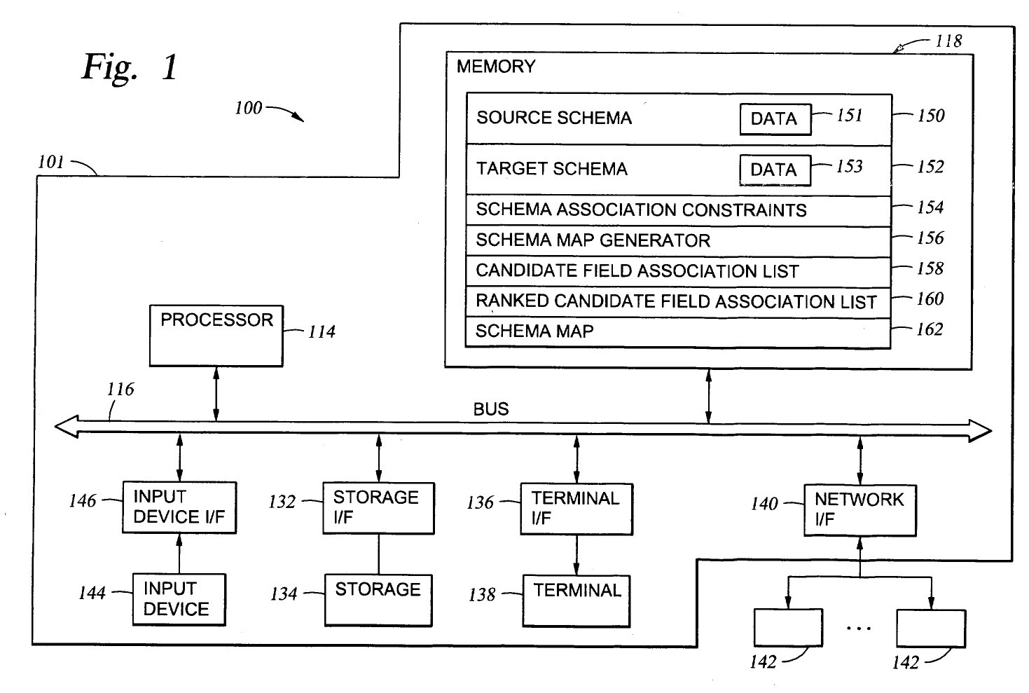

FIG. 1 shows a system 100 according to an embodiment. Illustratively, the system 100 includes a computer 101 having a system bus 116, at least one processor 114 coupled to the system bus 116. The computer 101 also includes an input device 144 coupled to system bus 116 via an input interface 146, a storage device 134 coupled to system bus 116 via a mass storage interface 132, a terminal 138 coupled to system bus 116 via a terminal interface 136, and a plurality of networked devices 142 coupled to system bus 116 via a network interface 140.

Terminal 138 is any display device such as a cathode ray tube (CRT) or a plasma screen. Terminal 138 and networked devices 142 may be desktop or PC-based computers, workstations, network terminals, or other networked computer systems. Input device 144 can be any device to give input to the computer 101. For example, a keyboard, keypad, light pen, touch screen, button, mouse, track ball, or speech recognition unit could be used. Further, although shown separately from the input device, the terminal 138 and input device 144 could be combined. For example, a display screen with an integrated touch screen, a display with an integrated keyboard or a speech recognition unit combined with a text speech converter could be used.

Storage device 134 is DASD (Direct Access Storage Device), although it could be any other storage such as floppy disc drives or optical storage. Although storage 134 is shown as a single unit, it could be any combination of fixed and/or removable storage devices, such as fixed disc drives, floppy disc drives, tape drives, removable memory cards, or optical storage. Main memory 118 and storage device 134 could be part of one virtual address space spanning multiple primary and secondary storage devices.

The contents of main memory 118 can be loaded from and stored to the storage device 134 as processor 114 has a need for it. Main memory 118 is any memory device sufficiently large to hold the necessary programming and data structures of the invention. The main memory 118 could be one or a combination of memory devices, including random access memory (RAM), non-volatile or backup memory such as programmable or flash memory or read-only memory (ROM). The main memory 118 may be physically located in another part of the system 100. While main memory 118 is shown as a single entity, it should be understood that memory 118 may in fact comprise a plurality of modules, and that main memory 118 may exist at multiple levels, from high speed registers and caches to lower speed but larger DRAM chips.

Illustratively, the memory 118 is shown containing a source schema 150 and associated data 151, a target schema 152 and associated data 153, a schema association constraints data structure 154, a schema map generator 156, a candidate field association list 158, a ranked candidate field association list 160 and a schema map 162. It is understood that the memory 118 may also contain any variety of typical software contents including applications, an operating system and the like. For simplicity, such components have not been shown.

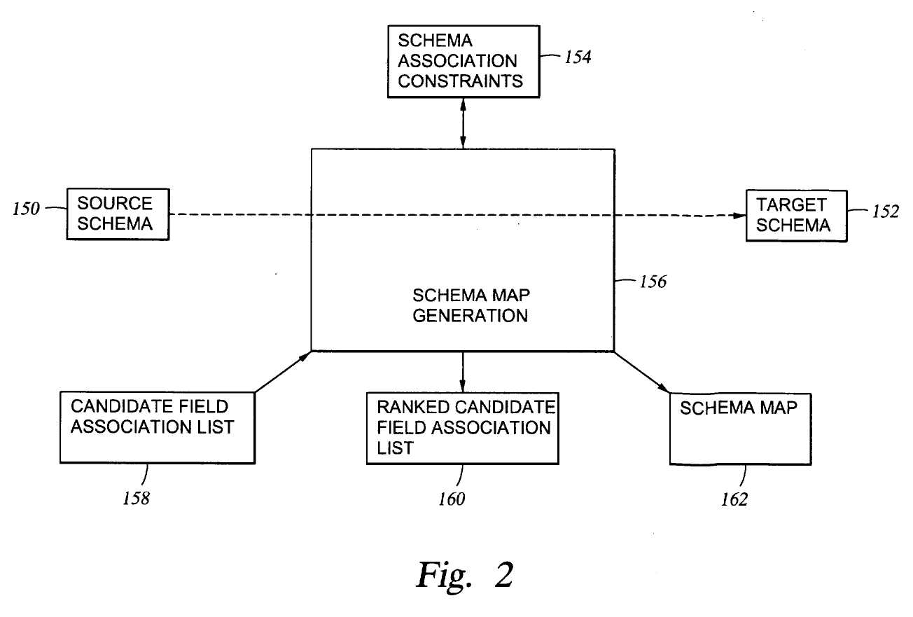

Referring now to FIG. 2, a relational/logical view is shown of the software components shown residing in memory 118 of FIG. 1. Generally, the source schema 150 provides a first model for the organization of source data 151 and the target schema 152 provides a second model (different from the first model) for the organization of target data 153. The schema association constraints data structure 154 contains metadata (also referred to herein as “constraints”) characterizing the fields of the target schema 152. Using the schema association constraints data structure 154, the schema map generator 156 identifies fields in the source schema 150 which may be mapped to fields in the target schema 152. The resulting output of the schema map generator 156 is a schema map 162, which is specific to a particular target schema. Accordingly, a different schema map is generated for each target schema. Although only one source schema 150 and one target schema 152 are shown, it is understood that any number of source schemas may be mapped to the target schema 152, or to a number of target schemas. The candidate field association list 158 and ranked candidate field association list 160 are data structures populated/managed by the schema map generator 156 in one embodiment. These data structures will be described in more detail below.

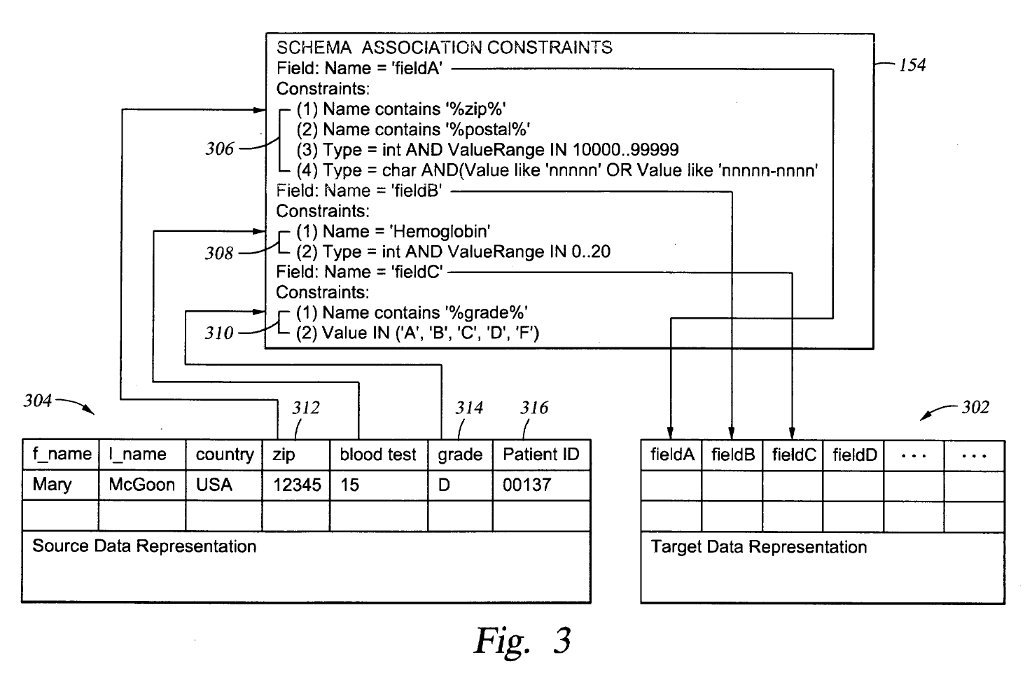

FIG. 3 shows one embodiment of the schema association constraints data structure 154 for an illustrative target data representation 302 which conforms to the target schema 152. In general, the schema association constraints data structure 154 characterizes various fields of the target data representation 302. In the particular example illustrated by FIG. 3 the schema association constraints data structure 154 characterizes fieldA, fieldB and fieldC of the target data representation 302. A first constraints set 306 for fieldA specifies four constraints, while the constraints set 308 and 310 for fieldB and fieldC, respectively, each specify two constraints. Each constraint in each constraints set is used by the schema map generator 156 to narrow the candidate fields in the source schema 150 which could be associated with (i.e., mapped to) the field in the target schema 152 for which the constraints set is defined. It is possible that, for a given target field, two or more source fields satisfy at least one of the corresponding constraints for the target field. Accordingly, in one embodiment, the constraints of each set are ranked, as indicated by the numerical rank value in parentheses (e.g., (1), (2), (3), etc.) preceding the respective constraints. The rank values may be used to facilitate mapping the source schema 150 to the target schema 152, as will be described in more detail below.

A number of different types of constraints are contemplated. By way of example only, illustrative constraint types include name-based constraints, type-based constraints and value-based constraints. A name-based constraint specifies a value or pattern for a field name, and is used to locate fields in the source schema 150 that have the same or similar name or name pattern. Examples of name-based constraints are the first and second constraints of the first constraints set 306 (for fieldA), and the first constraints of the second and third constraints sets 308 and 310 (for fieldB and fieldC, respectively). Thus, for example, the first constraint for the target fieldA specifies a string “zip”. Illustratively, the source schema has a zip code field 312 designated by the string “zip”. Accordingly, the zip code field 312 satisfies the first constraint for the target fieldA.

Type-based constraints identify a particular data type that a target field expects for a matching field in the source schema 150. Examples of type-based constraints include the last two constraints of the first constraints set 306 and the last constraint of the second constraints set 308. Note that these constraints also exemplify that target field constraints may include logical operators (OR, AND, NOT). For example, the third constraint of the first constraint set 306 is a type-based constraint configured to identify source schema fields having values which are both integers and within a numerical range of 10000 to 99999. Accordingly, the zip code field 312 satisfies both the first constraint and the third constraint of the first constraints set 306 for the target fieldA.

Value-based constraints for a target field identify a set of values that a matching field in the source schema must contain in order to be mapped to the target field. A variety of different value-based constraints are contemplated including list oriented constraints, range oriented constraints, statistical constraints and unique value constraints. List oriented constraints are used by the schema map generator 156 to search for an explicit list of values within fields in the source schema. Range oriented constraints specify a range for the values that are searched for in the source schema. Unique value constraints would match only those fields in the source schema whose associated values are unique. Statistical constraints match only those fields in the source schema whose value meet a given statistical distribution or mean specified within the constraint.

It is understood that name-based constraints, type-based constraints and value-based constraints are merely illustrative, and other constraints are contemplated and will be recognized by those skilled in the art. For example, structural constraints are contemplated whereby a pattern of related fields in the source schema provide a match for a field in the target schema. An example is where the target schema includes a full name field and a structural constraint could be a combination of two or three name fields. Yet another example is a color constraint whereby the constraint is used to identify fields referencing images containing the specified color values. It is also contemplated that constraint information may be sourced from industry standard schema definitions. For example, an XML schema definition may exist, defining the standard, expected format for a purchase order. A constraint could reference such existing schema to derive metadata needed for constraint analysis performed according to the present invention. Persons skilled in the art will recognize other embodiment.

Having defined the various constraints for a particular target schema, the schema map generator 156 implements a method (according to a schema map generation algorithm) for evaluating the target schema with the constraints against one or more source schemas. The schema map generation method uses the constraint details provided along with information on the source schema and values associated with fields in the source schema to provide a recommendation on fields in the source schema that would be candidates to map to the given fields in the target schema. In general, for each field in the target schema, the method entails getting the constraint metadata for the target field, evaluating the specified constraints against fields in the source schema, and then providing a ranked set of source-fields-to-target-fields mapping recommendations. It is contemplated that any number of different ranking techniques may be used. In one embodiment, the individual constraints are ranked (as in the illustrative schema association constraints data structure 154 shown in FIG. 3) and those rankings are used to rank fields which match the constraints, i.e., a field satisfying a higher ranked constraint would be ranked higher than fields satisfying lower ranked constraints. Another embodiment ranks the source fields based on the number of constraints they satisfied. In still another embodiment, a combination of the foregoing two approaches is used, wherein a weighted average is calculated for each of the source fields based on the ranking of each matching constraint. Persons skilled in the art will recognize other embodiments.

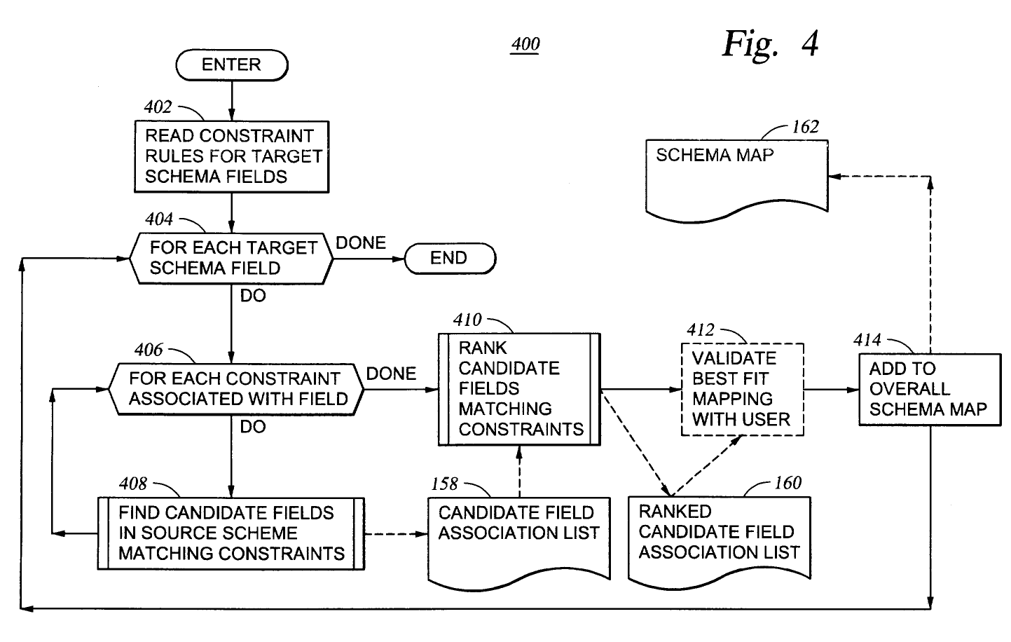

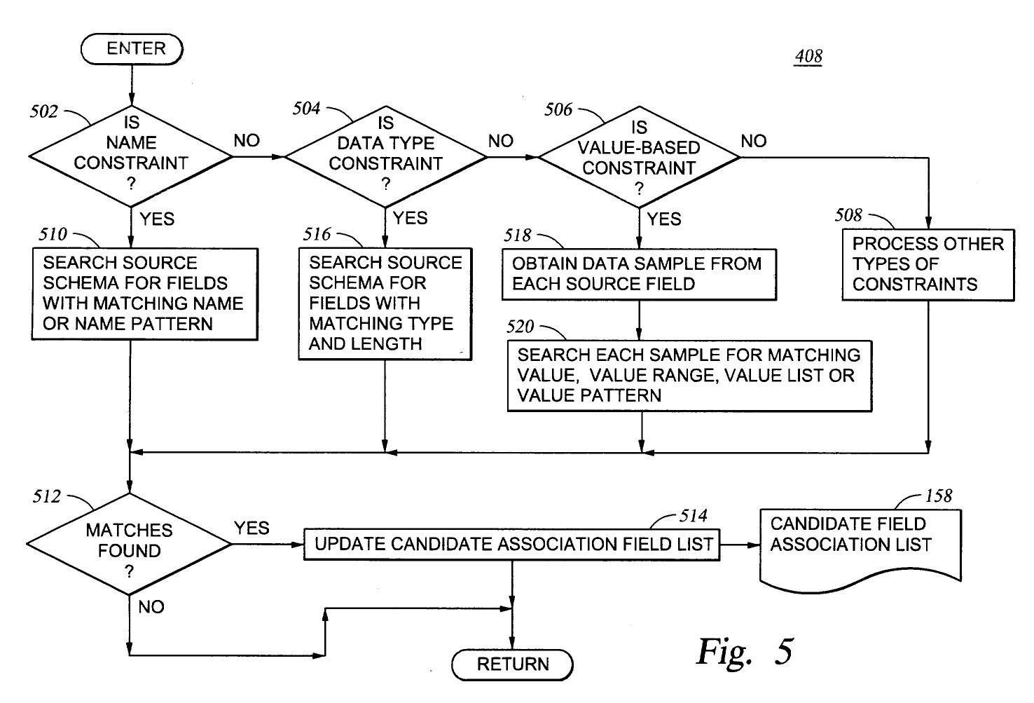

Referring now to FIG. 4, one embodiment of a constraint-based schema mapping method 400 implemented by the schema map generator 156 is shown. In a preferred embodiment, the method 400 is performed only once since the resulting schema map 162 is a persistent object which can be referenced for the mappings specified therein. The method 400 is entered at step 402 where the constraint rules for a given target schema are read. The method 400 then enters a loop (more particularly, a loop and a sub-loop defined by steps 404 and 406) which is performed for each constraint defined for each target schema field of a target schema. Thus, for a given target schema field of a target schema, a given constraint defined for that field (which is specified in the schema association constraints data structure 154 of the target schema) is compared to the source schema in order to locate candidate fields of the source schema which match the given constraint. Each candidate field of the source schema is placed into a candidate field association list 158. This sub-loop (defined by step 406) is performed for each constraint defined for the given target schema field (i.e., for each constraint defined in the schema association constraints data structure 154 for a given target schema field). For example, with reference to the illustrative schema association constraints data structure 154 shown in FIG. 3, candidate fields in the source schema are matched against the constraints of each of the constraint set 306, 308 and 310 for fieldA, fieldB and fieldC, respectively.

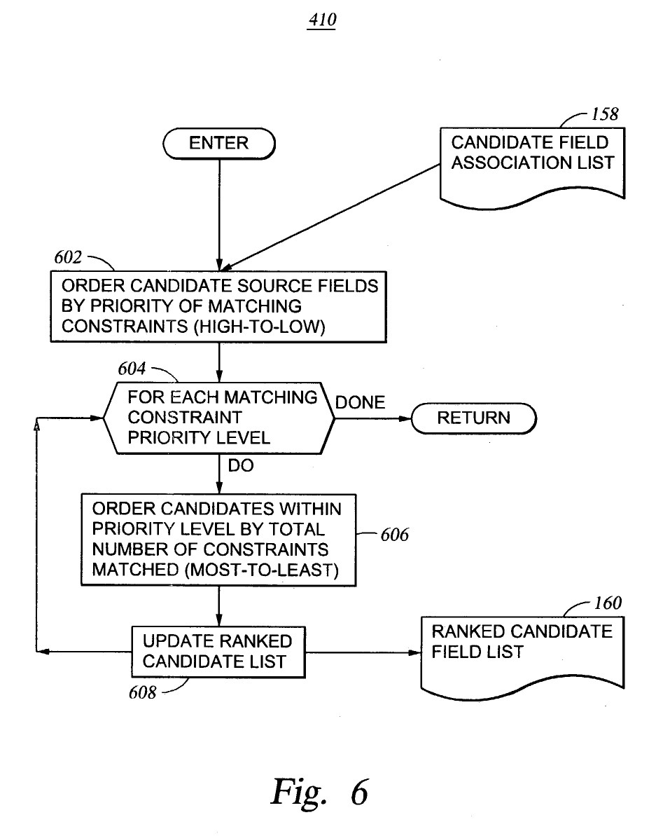

Having populated a candidate field association list 158, the candidate source fields in the list 158 are ranked to produce the ranked candidate field association list 160. Various ranking techniques have been described above and a particular embodiment will be described with reference to FIG. 6.

In one embodiment, the ranked candidate field association list 160 is then displayed to a user. The user may then validate the suggested mappings in the ranked candidate field association list 160, as sorted by step 410, or may manually alter the suggested mappings. In other embodiments, the user is not given the opportunity to validate or modify the mappings derived at step 410. In any case, the suggested mappings are then added to the schema map 162.

The steps of the sub-loop 406 are then repeated for each target schema field of the target schema. As a result, the schema map 162 may provide mappings for each target field having defined constraints in the schema association constraints data structure 154.

Referring now to FIG. 5, one embodiment for identifying source schema candidate fields according to step 408 of FIG. 4 is shown. Initially, the method 408 determines the type of constraint being processed to identify matching source schema fields. Accordingly, a determination is made as to whether the constraint is a name-based constraint (step 502), a data-type constraint (step 504) or a value-based constraint (step 506). If the constraint is a name-based constraint, the source schema is searched for fields with matching names or name patterns (step 510). If a match is found (step 512), the candidate field association list 158 is updated (step 514). Otherwise, the method 408 returns (i.e., begins processing the next constraint associated with the particular target schema field being processed, as represented by step 406 of FIG. 4). If the constraint is a data-type constraint, the source schema is searched for fields with matching type and/or length (step 516). If a match is found (step 512), the candidate field association list 158 is updated (step 514). Otherwise, the method 408 returns. If the constraint is a value-based constraint, a data sample is obtained from each source schema field (step 518). Each sample is then searched for a matching value, value range, value list or value pattern (step 520). If a match is found (step 512), the candidate field association list 158 is updated (step 514). Otherwise, the method 408 returns. Since the foregoing constraints are merely illustrative, the method 408 also provides for handling any other type of constraints at step 508. If a match is found (step 512), the candidate field association list 158 is updated (step 514). Otherwise, the method 408 returns.

Referring now to FIG. 6, one embodiment for ranking candidate source fields (step 410 of FIG. 4) is shown. Having produced the candidate field association list 158, the source fields contained in the list 158 are ordered by priority of the matching constraints. For example, with regard to the constraints set 306 for fieldA of the target schema, both the zip field 312 and the ID field 316 of the source schema satisfy one or more of the constraints. The highest ranking constraint satisfied by the zip field 312 is the first (1) constraint and the highest ranking constraint satisfied by the ID field 316 is the fourth (4) constraint. Because the first constraint is ranked higher than the fourth constraint, the zip field 312 of the source schema is ranked higher than the patient ID field 316 in the ranked candidate field association list 160.

However, in some cases a tie may result. Again with reference to the zip field 312 and the patient ID field 316, it can be seen that the zip field 312 satisfies both the first (1) constraint, the third (3) constraint and the fourth (4) constraint. A grade field 314 satisfies both the first (1) constraint and the second (2) constraint of the third constraints set 310. Thus, both the zip field 312 and a grade field 314 satisfy the highest priority constraint level, i.e., priority level one (1). A tie-breaking algorithm is therefore entered at step 604 for each matching constraint priority level, for a particular target schema field (since step 604 is a sub-loop of step 404). Specifically, the source schema field candidates for a given priority level (and for a particular target schema field) are ordered based on the total number of constraints they satisfy (step 606). Therefore, because the total number of constraints satisfied by the zip field 312 (i.e., three fields) is greater than the total number of field satisfied by the grade field 314 (i.e., two fields), the zip field 312 is ranked higher than the grade field 314 in the ranked candidate field association list 160. At step 608, the ranked candidate list 160 is updated. The loop entered at step 604 is repeated for each matching constraint priority level.

As noted above, various ranking techniques are contemplated and FIG. 6 represents only one of many embodiments. For example, it was noted above that source schema field candidates may be ranked solely according to the number of constraints matched (without regard to an initial priority level sorting, as performed at step 602).

Accordingly, aspects of the invention provide for automating the mapping process between two different schemas using constraints defined for each field of a target schema. Because constraints are used to characterize acceptable mappings for a given field, the present invention provides accurate recommendations on associations between fields described in the two different schemas. The metadata which defines the set of constraints that apply to a particular field could be associated with a number of different schema representation languages. By way of illustration, the following describes one embodiment in which the constraints appear as additional metadata associated with logical fields defined within a data abstraction model.

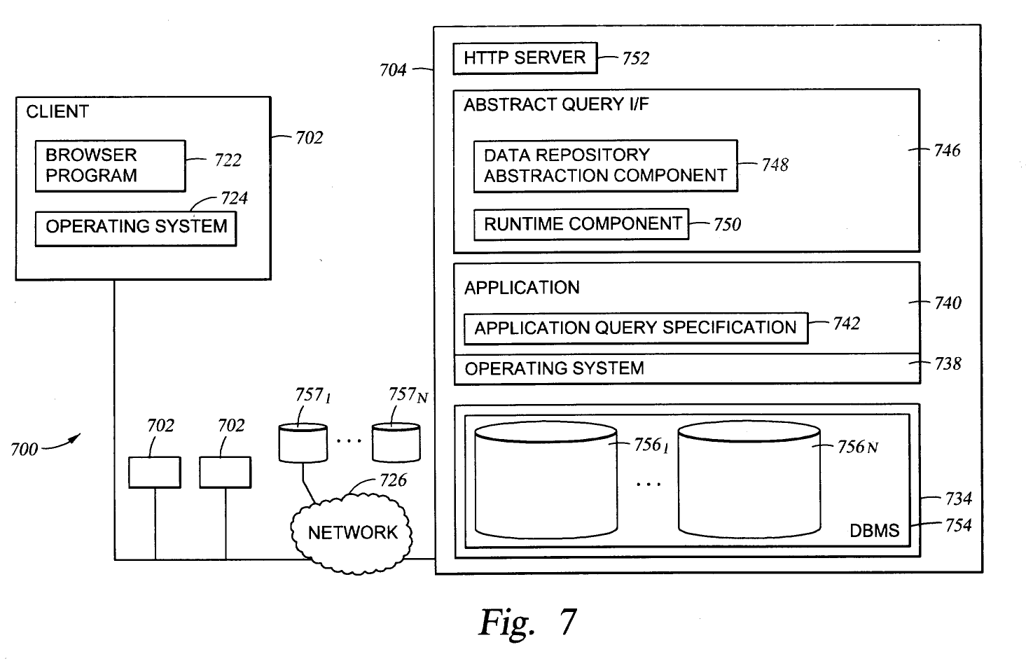

FIG. 7 shows one embodiment of a networked system 700 (e.g., a client-server environment) in which aspects of the invention are implemented as part of a data abstraction model (hereafter referred to as a “data repository abstraction component”). In general, the networked system 700 includes a client (e.g., user's) computer 702 (three such client computers 702 are shown) and at least one server 704 (one such server 704). The client computer 702 and the server computer 704 are connected via a network 726. In general, the network 726 may be a local area network (LAN) and/or a wide area network (WAN). In a particular embodiment, the network 726 is the Internet.

The client computer is configured with one or more applications 740 and an abstract query interface 746. The applications 740 and the abstract query interface 746 are software products comprising a plurality of instructions that are resident at various times in various memory and storage devices in the computer system 700. When read and executed by one or more processors 730 in the server 704, the applications 740 and the abstract query interface 746 causes the computer system 700 to perform the steps necessary to execute steps or elements described below. The applications 740 (and more generally, any requesting entity, including the operating system 738 and, at the highest level, users via a browser 722) issue queries against a database. Illustrative against which queries may be issued include local databases 756₁ . . . 756_{N}, and remote databases 757₁ . . . 757_{N}, collectively referred to as database(s) 756-757). Illustratively, the databases 756 are shown as part of a database management system (DBMS) 754 in storage 734. More generally, as used herein, the term “databases” refers to any collection of data regardless of the particular physical representation. By way of illustration, the databases 756-757 may be organized according to a relational schema (accessible by SQL queries) or according to an XML schema (accessible by XML queries). As a result of disparate schemas, it is desirable to produce a schema map as described above. To this end, a data repository abstraction component 748 is provided and configured with the necessary metadata (i.e., the information contained in the schema association constraints data structure 154, described above) to produce the schema map.

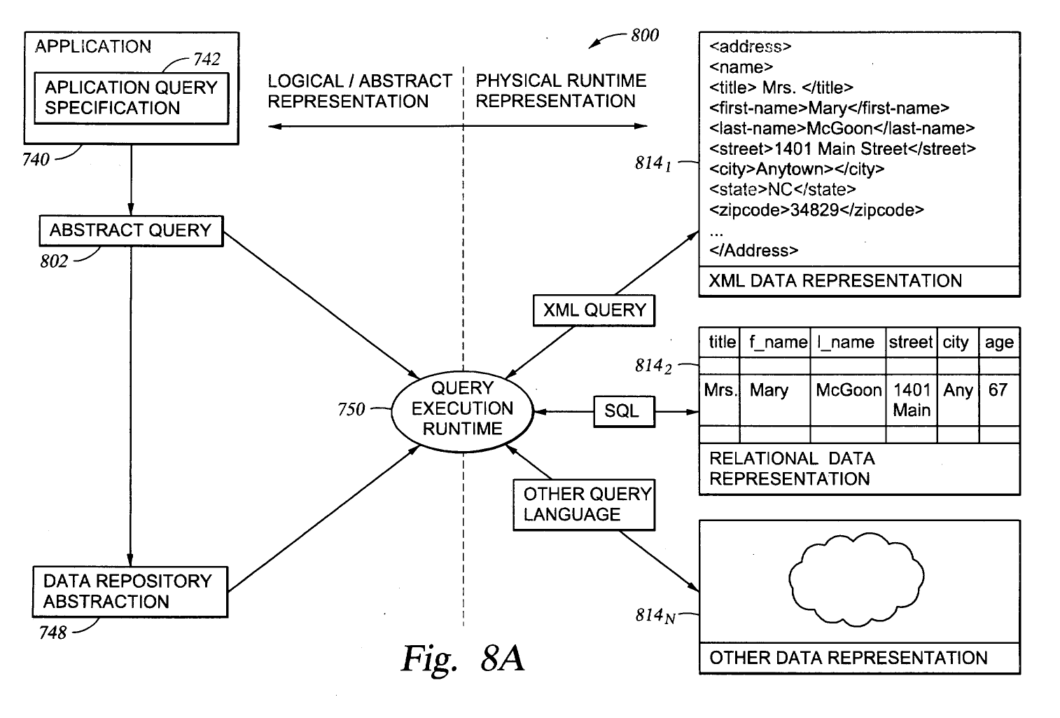

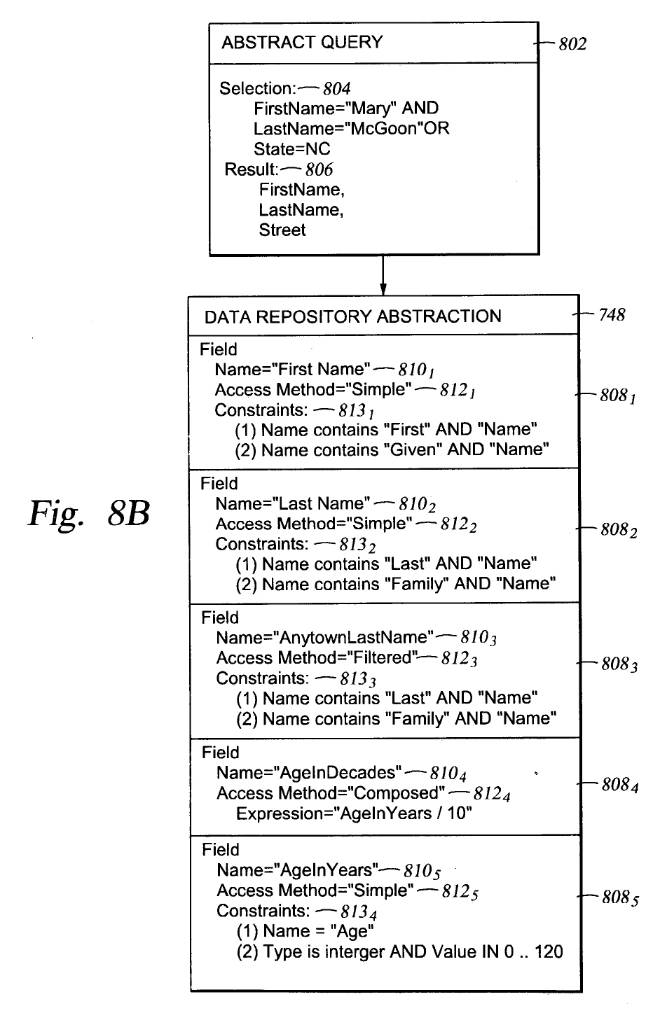

In one embodiment, the queries issued by the applications 740 are defined according to an application query specification 742 included with each application 740. The queries issued by the applications 740 may be predefined (i.e., hard coded as part of the applications 740) or may be generated in response to input (e.g., user input). In either case, the queries (referred to herein as “abstract queries”) are composed using logical fields defined by the abstract query interface 746. In particular, the logical fields used in the abstract queries are defined by the data repository abstraction component 748 of the abstract query interface 746. The abstract queries are executed by a runtime component 750 which transforms the abstract queries into a form consistent with the physical representation of the data contained in one or more of the databases 756-757. The application query specification 742, the abstract query interface 746 and the data repository abstraction component 748 are further described with reference to FIGS. 8A-B.

In one embodiment, elements of a query are specified by a user through a graphical user interface (GUI). The content of the GUIs is generated by the application(s) 740. In a particular embodiment, the GUI content is hypertext markup language (HTML) content which may be rendered on the client computer systems 702 with the browser program 722. Accordingly, the memory 732 includes a Hypertext Transfer Protocol (http) server process 738 (e.g., a web server) adapted to service requests from the client computer 702. For example, the process 738 may respond to requests to access a database(s) 756, which illustratively resides on the server 704. Incoming client requests for data from a database 756-757 invoke an application 740. When executed by the processor 730, the application 740 causes the server computer 704 to perform various steps, including accessing the database(s) 756-757. In one embodiment, the application 740 comprises a plurality of servlets configured to build GUI elements, which are then rendered by the browser program 722. Where the remote databases 757 are accessed via the application 740, the data repository abstraction component 748 is configured with a location specification identifying the database containing the data to be retrieved. This latter embodiment will be described in more detail below.

FIG. 7 is merely one hardware/software configuration for the networked client computer 702 and server computer 704. Embodiments of the present invention can apply to any comparable hardware configuration, regardless of whether the computer systems are complicated, multi-user computing apparatus, single-user workstations, or network appliances that do not have non-volatile storage of their own. Further, it is understood that-while reference is made to particular markup languages, including HTML, the invention is not limited to a particular language, standard or version. Accordingly, persons skilled in the art will recognize that the invention is adaptable to other markup languages as well as non-markup languages and that the invention is also adaptable future changes in a particular markup language as well as to other languages presently unknown. Likewise, the http server process 738 shown in FIG. 7 is merely illustrative and other embodiments adapted to support any known and unknown protocols are contemplated.

### Logical/Runtime View of Environment

FIGS. 8A-B show a plurality of interrelated components of the invention. The requesting entity (e.g., one of the applications 740) issues a query 802 as defined by the respective application query specification 742 of the requesting entity. The resulting query 802 is generally referred to herein as an “abstract query” because the query is composed according to abstract (i.e., logical) fields rather than by direct reference to the underlying physical data entities in the databases 756-757. As a result, abstract queries may be defined that are independent of the particular underlying data representation used. In one embodiment, the application query specification 742 may include both criteria used for data selection (selection criteria 804) and an explicit specification of the fields to be returned (return data specification 806) based on the selection criteria 804.

The logical fields specified by the application query specification 742 and used to compose the abstract query 802 are defined by the data repository abstraction component 748. In general, the data repository abstraction component 748 exposes information (e.g., data in the databases 756-757) as a set of logical fields that may be used within a query (e.g., the abstract query 802) issued by the application 740 to specify criteria for data selection and specify the form of result data returned from a query operation. The logical fields are defined independently of the underlying data representation being used in the databases 756-757, thereby allowing queries to be formed that are loosely coupled to the underlying data representation.

In general (referring now to FIG. 8B), the data repository abstraction component 748 comprises a plurality of field specifications 808₁, 808₂, 808₃, 808₄ and 808₅ (five shown by way of example), collectively referred to as the field specifications 808. Specifically, a field specification is provided for each logical field available for composition of an abstract query. Each field specification comprises a logical field name 810₁, 810₂, 810₃, 810₄, 810₅ (collectively, field name 810) and an associated access method 812₁, 814₂, 812₃, 812₄, 812₅ (collectively, access method 812). The access methods associate (i.e., map) the logical field names to a particular physical data representation 814₁, 814₂ . . . 814_{N} in a database (e.g., one of the databases 756-757). By way of illustration, two data representations are shown, an XML data representation 814₁ and a relational data representation 814₂. However, the physical data representation 814_{N} indicates that any other data representation, known or unknown, is contemplated. For example, in one embodiment, a data repository abstraction component 748 is configured with access methods for procedural data representations.

In one embodiment, a different single data repository abstraction component 748 is provided for each separate physical data representation 814. In an alternative embodiment, a single data repository abstraction component 748 contains field specifications (with associated access methods) for two or more physical data representations 814. In yet another embodiment, multiple data repository abstraction components 748 are provided, where each data repository abstraction component 748 exposes different portions of the same underlying physical data (which may comprise one or more physical data representations 814). In this manner, a single application 740 may be used simultaneously by multiple users to access the same underlying data where the particular portions of the underlying data exposed to the application are determined by the respective data repository abstraction component 748. In still another embodiment, a single data repository abstraction component 748 may be extended to include description of a multiplicity of data sources (e.g., databases 756-757) that can be local and/or distributed across a network environment. The data sources can be using a multitude of different data representations and data access techniques. In one embodiment, this is accomplished by configuring the access methods of the data repository abstraction component 748 with a location specification defining a location of the data associated with the logical field, in addition to the method used to access the data. Details of employing the data repository abstraction component 748 in a distributed data environment is described in detail in commonly owned U.S. patent application Ser. No. 10/131,984, entitled “REMOTE DATA ACCESS AND INTEGRATION OF DISTRIBUTED DATA SOURCES THROUGH DATA SCHEMA AND QUERY ABSTRACTION”, (hereinafter application '984) which is hereby incorporated by reference in its entirety.

In any case, an access method represents an established mapping between a logical field specification defined within a data repository abstraction and a data item in the underlying physical data environment. Further, for a given data repository abstraction component, any number of access methods are contemplated depending upon the number of different types of logical fields to be supported. In one embodiment, access methods for simple fields, filtered fields and composed fields are provided. The field specifications 808₁, 808₂ and 808₅ exemplify simple field access methods 812₁, 812₂, and 812₅, respectively. Simple fields are mapped directly to a particular entity in the underlying physical data representation (e.g., a field mapped to a given database table and column). The field specification 808₃ exemplifies a filtered field access method 812₃. Filtered fields identify an associated physical entity and provide rules used to define a particular subset of items within the physical data representation. An example of a filtered field is a New York ZIP code field that maps to the physical representation of ZIP codes and restricts the data only to those ZIP codes defined for the state of New York. The field specification 808₄ exemplifies a composed field access method 812₄. Composed access methods compute a logical field from one or more physical fields using an expression supplied as part of the access method definition. In this way, information which does not exist in the underlying data representation may computed. In the example illustrated in FIG. 8B the composed field access method 812₃ maps the logical field name 810₃ “AgeInDecades” to “AgeInYears/10”. Another example is a sales tax field that is composed by multiplying a sales price field by a sales tax rate.

Application '984, previously incorporated by reference, describes a manner of specifying the physical data fields to which a logical field is mapped. The present invention, however, addresses the need to associate the same set of logical field specifications defined in the data repository abstraction component 748 with alternate physical data representations (i.e., schemas). In other cases, the data repository abstraction component 748 may be partially defined (e.g., definition of logical fields within mapping to a specific physical data environment) with the intent to associate logical items in the data repository abstraction component 748 with a given physical data representation at a later point in time. Aspects of the present invention facilitate association of a given data repository abstraction with alternate physical data instances (i.e., schemas). This can be accomplished by supplementing the metadata in the data repository abstraction component 748 with a mapping constraint set for each logical field.

FIG. 8B provides a number of examples showing how metadata associated with logical fields in the data repository abstraction component 748 can include mapping constraint set definitions. In FIG. 8B, field specification 808₁ having a name 810₁ of “First Name”, has a constraint set 813₁ with two mapping constraints defined that match fields in a source schema named either “First Name” or “Given Name”. Thus, the simple field access method 812₁ maps the logical field name 810₁ to, for example, a column named “first name” in a table of a relational database. The other field specifications 808₂-808₃ and 808₅ each have respective constraint sets 813₂-813₃ and 813₅. One field specification 808₄ is shown without a constraint set to indicate that not all 808₄ need have a constraint set.

Having configured the data repository abstraction component 748 with constraints for one or more logical fields, a schema map generator (such as the schema map generator 156 shown in FIG. 2) can be used to map items in a particular physical data environment to access method definitions for each logical field in the data repository abstraction component 748 based on fields in the physical data environment which match the specified constraint set. A schema mapping generation process has been generally described above with respect to FIGS. 4-6. During runtime, the data repository abstraction component 748 is used to access data according to its field specifications and schema map. The runtime environment is described in detail in application '984 previously incorporated by reference.

While the foregoing is directed to embodiments of the present invention, other and further embodiments of the invention may be devised without departing from the basic scope thereof, and the scope thereof is determined by the claims that follow.

What is claimed is:

1. A method of mapping schemas, comprising:
retrieving constraint data for a first schema, wherein the constraint data characterizes a field of the first schema;
for each field of a second schema, determining whether the field of the second schema satisfies the constraint data; and
if so, mapping the field of the second schema to the field of the first schema.

2. The method of claim 1, further comprising, prior to mapping:
displaying an indication that the field of the second schema satisfies the constraint; and
requesting user confirmation to map the field of the second schema to the field of the first schema.

3. The method of claim 1, wherein the constraint data is a name constraint specifying at least one of a name or name pattern, and wherein the determining step comprises searching the second schema for fields matching the name constraint.

4. The method of claim 1, wherein the constraint data is a data type constraint specifying a type and a length, and wherein the determining step comprises searching the second schema for fields with a matching type and length.

5. The method of claim 1, wherein the constraint data is a value-based constraint specifying at least one of a value, a value range, a value list and a value pattern, and wherein the determining step comprises obtaining a data sample from each field of the second schema and searching each data sample for data satisfying the value-based constraint.

6. The method of claim 1, wherein different constraint data is defined for each field of the first schema and retrieving and determining are performed for the respective different constraint data for each field of the first schema.

7. The method of claim 6, wherein the constraint data is selected from at least one of name-based constraints, type-based constraints and value-based constraints.

8. A method of mapping schemas, comprising:
retrieving constraint data for a first schema, wherein the constraint data comprises a plurality of constraints each characterizing one of a plurality of fields of the first schema; and
for each of the plurality of constraints which characterizes a particular one of the plurality of fields of the first schema, determining whether any fields of a second schema satisfy the constraint;
ranking each field of the second schema which satisfies at least one of the plurality of constraints; and
mapping a highest ranked field of the second schema which satisfies at least one of the plurality of constraints to the particular one field of the first schema characterized by the constraint.

9. The method of claim 8, wherein the constraint data is a name constraint specifying at least one of a name or name pattern, and wherein the determining step comprises searching the second schema for fields matching the name constraint.

10. The method of claim 8, wherein the constraint data is a data type constraint specifying a type and a length, and wherein the determining step comprises searching the second schema for fields with a matching type and length.

11. The method of claim 8, wherein the constraint data is a value-based constraint specifying at least one of a value, a value range, a value list and a value pattern, and wherein the determining step comprises obtaining a data sample from each field of the second schema and searching each data sample for data satisfying the value-based constraint.

12. The method of claim 8, wherein the determining, ranking and mapping is performed for each of the plurality of fields of the first schema.

13. The method of claim 8, wherein the constraint data is selected from at least one of name-based constraints, type-based constraints and value-based constraints.

14. The method of claim 8, wherein at least some of the plurality of fields of the first schema are characterized by two or more constraints.

15. The method of claim 14, wherein each of the two or more constraints have an assigned priority level, and wherein ranking comprises sorting the fields of the second schema according to priority levels of the constraints satisfied by the fields of the second schema.

16. The method of claim 14, wherein ranking comprises sorting the fields of the second schema according to a number of the constraints satisfied by each of the fields of the second schema.

17. A computer readable medium containing a program which, when executed, performs an operation of mapping schemas, the operation comprising:
retrieving constraint data for a first schema, wherein the constraint data characterizes a field of the first schema;
for each field of a second schema, determining whether the field of the second schema satisfies the constraint data; and
if so, mapping the field of the second schema to the field of the first schema.

18. The computer readable medium of claim 17, further comprising, prior to mapping:
displaying an indication that the field of the second schema satisfies the constraint; and
requesting user confirmation to map the field of the second schema to the field of the first schema.

19. The computer readable medium of claim 17, wherein the constraint data is a name constraint specifying at least one of a name or name pattern, and wherein the determining step comprises searching the second schema for fields matching the name constraint.

20. The computer readable medium of claim 17, wherein the constraint data is a data type constraint specifying a type and a length, and wherein the determining step comprises searching the second schema for fields with a matching type and length.

21. The computer readable medium of claim 17, wherein the constraint data is a value-based constraint specifying at least one of a value, a value range, a value list and a value pattern, and wherein the determining step comprises obtaining a data sample from each field of the second schema and searching each data sample for data satisfying the value-based constraint.

22. The computer readable medium of claim 17, wherein different constraint data is defined for each field of the first schema and retrieving and determining are performed for the respective different constraint data for each field of the first schema.

23. The computer readable medium of claim 17, wherein the constraint data is selected from at least one of name-based constraints, type-based constraints and value-based constraints.

24. The computer readable medium of claim 17, wherein different constraint data is defined for each field of the first schema and retrieving and determining are performed for the respective different constraint data for each field of the first schema.

25. The computer readable medium of claim 17, wherein mapping comprises generating a schema map which maps each individual field of the first schema to a field of the second schema satisfying the constraint data of the individual field of the first schema.

26. A computer readable medium containing a program which, when executed, performs an operation of mapping schemas, the operation comprising:
retrieving constraint data for a first schema, wherein the constraint data comprises a plurality of constraints each characterizing one of a plurality of fields of the first schema;
for each of the plurality of constraints which characterizes a particular one of the plurality of fields of the first schema, determining whether any fields of a second schema satisfy the constraint;
ranking each field of the second schema which satisfies at least one of the plurality of constraints; and
mapping a highest ranked field of the second schema which satisfies at least one of the plurality of constraints to the particular one field of the first schema characterized by the constraint.

27. The computer readable medium of claim 26, wherein the constraint data is a name constraint specifying at least one of a name or name pattern, and wherein the determining step comprises searching the second schema for fields matching the name constraint.

28. The computer readable medium of claim 26, wherein the constraint data is a data type constraint specifying a type and a length, and wherein the determining step comprises searching the second schema for fields with a matching type and length.

29. The computer readable medium of claim 26, wherein the constraint data is a value-based constraint specifying at least one of a value, a value range, a value list and a value pattern, and wherein the determining step comprises obtaining a data sample from each field of the second schema and searching each data sample for data satisfying the value-based constraint.

30. The computer readable medium of claim 26, further comprising, following ranking and before mapping:
displaying a ranked list of each field of the second schema which satisfies at least one of the plurality of constraints; and
requesting user confirmation to map the highest ranked field of the second schema to the particular one of the plurality of fields of the first schema.

31. The computer readable medium of claim 26, wherein the determining, ranking and mapping is performed for each of the plurality of fields of the first schema.

32. The computer readable medium of claim 26, wherein the constraint data is selected from at least one of name-based constraints, type-based constraints and value-based constraints.

33. The computer readable medium of claim 26, wherein at least some of the plurality of fields of the first schema are characterized by two or more constraints.

34. The computer readable medium of claim 33, wherein each of the two or more constraints have an assigned priority level, and wherein ranking comprises sorting the fields of the second schema according to priority levels of the constraints satisfied by the fields of the second schema.

35. The computer readable medium of claim 33, wherein ranking comprises sorting the fields of the second schema according to a number of the constraints satisfied by each of the fields of the second schema.

36. A system for mapping schemas, comprising a memory containing at least:
a source schema defining a plurality of source fields;
a target schema defining a plurality of target fields;
schema association constraints defined for the target schema and comprising a constraints set for each of the plurality of target fields, wherein constraints defined by the constraints set for a given target field characterize acceptable field attributes from the source schema for the given target field; and
a schema map generator configured to map one or more of the plurality of target fields to one or more of the plurality of source fields according to the schema association constraints.

37. The system of claim 36, wherein, for the given target field, the schema map generator is configured determine which of the plurality of source fields satisfies the constraints set corresponding to the given target field.

38. The system of claim 37, wherein the schema map generator is configured to rank the plurality of source fields which satisfy the constraints set corresponding to be given target field.
